(19) United States
(12) Patent Application Publication
(10) Pub. No.: US 2011/0007508 A1
(43) Pub. Date: Jan. 13, 2011

(54) METHOD FOR FORMING RANDOM LIGHT PATTERN AND LAMP FOR THE SAME

(76) Inventors: Kun-Jung CHANG, Kaohsiung County (TW); Ching-Yuan JUAN, Kaohsiung County (TW); Kuo-Chun LIN, Kaohsiung County (TW); Ching-Huang JUAN, Kaohsiung County (TW)

Correspondence Address: Muncy, Geissler, Olds & Lowe, PLLC, 4000 Legato Road, Suite 310, FAIRFAX, VA, 22033, US

(21) Appl. No.: 12/500,215

(22) Filed: Jul. 9, 2009

(51) Int. Cl. F21S 4/00; H01J 9/24

(52) U.S. Cl. 362/249.03; 445/23

(57) ABSTRACT

A method for forming random light pattern and a lamp therefor according to the present invention can control the brightness and the light pattern of the light according to the user's need, emphasis the boundary between light and dark, and avoid energy consumption caused by illuminating to undesired region. In the present invention, based on the counter-projection technology, the number, the positions and the angles of the lighting elements in the holder can be inversely calculated from the desired light pattern, so that the test time and the cost both can be reduced.

### FIELD OF THE INVENTION

The present invention is related to a method for forming random light pattern and a lamp for the same, and more particularly to a technology for rapidly obtaining the positions, the number, the directions and the arrangement of the lighting elements in a light source, and also for randomly achieving any shape of light pattern by cooperating with a light holder which can have the lighting elements mounted thereon in various numbers, positions and directions.

### BACKGROUND OF THE INVENTION

The lighting in daily life is divided into decoration and practical usages. For maximizing the effect of lighting, the formed light pattern should be controlled to focus on a specific point and also prevent from light pollution owing to the light divergence.

The lighting for decoration usage should control the light pattern to be focused on the object and to provide uniform illumination and boundaries, so as to prevent from over-focused or divergent lighting which might destroy the balance. Moreover, for practical usage, the light pattern should be controlled to focus on the target region and provide sufficient and uniform illumination.

However, the method for forming light pattern in the prior art is always that the light source having multiple lighting elements is covered by a mask. The mask is located at the outer edge of the light source, so that the light only can penetrate from the uncovered portion. But, the mask will affect the uniformity of lighting or cause insufficient illumination, so as to influence the effect of the light pattern. Please refer to FIG. 1, as shown, through a reflection board 102a and multiple lighting elements 103a, this problem can be solved. However, because the reflection board 102a reflects light 100a in a secondary optical fashion, the illumination will attenuate after reflection, so that for compensation, the general way is to increase the power or the number of the lighting elements 103a, which actually will lead to heat dissipation problem. Besides, for the conventional light holder 101a, the lighting elements 103a are mounted on a plane and toward one identical direction which restricts the lighting range and illumination and cannot meet a user's requirement.

Furthermore, no matter adopting the mask or mounting multiple lighting elements, both need experiments to adjust the position, the arrangement, the formed light pattern, the illumination and the uniformity of lighting, which cost not only time but also money.

### SUMMARY OF THE INVENTION

The object of the present invention is to overcome the difficulty in forming the light pattern and the limitation caused by the light, wherein the illumination point is determined by the light pattern, including shape, position, size, and illumination, and through the counter-projection, the position of the light source can be obtained in a rapid and correct way.

For achieving the object of the present invention, based on the primary optical principle, according to the shape, the position, the size and the illumination of the desired light pattern, and in accordance with the position of the light source and the topography or the geography of the projected surface, the present invention divides the light pattern into several illumination points depending on the position of and the distance from the light source. For maintaining the illumination, the density of the illumination points is in reverse proportion to the square of the distance from the light source. Then, based on the counter-projection technology and the property that light travels in straight line, the connection points of the light source with the straight line from the illumination point to the light source are used to position the lighting elements, and the reverse direction of the straight line is the facing direction of the lighting element.

The lamp of the present invention is derived from U.S. application Ser. No. 11/907,279, wherein the lighting elements (e.g., LEDs) on the single holder surface can be adjusted to face any angle by the number, the positions and the directions thereof conform to the desired light pattern without reflection board.

Accordingly, the present invention is advantageous that:

1. The light pattern and the illumination can be configured randomly and rapidly, and the uniformity of the light pattern also can be controlled.

2. The positions and facing directions of the lighting elements can be handled easily and speedily, for saving test time and reducing cost.

3. One holder can have lighting elements facing multiple angles, which is different from the conventional light elements facing the same direction with using the reflection technology.

4. The light pattern is formed by lights from the lighting elements in a primary optical fashion, so that the illumination will not be attenuated by reflection and also the energy can be saved.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the conventional light forms the light pattern by a reflection board;

FIG. 2 is a flow chart of the present invention;

FIG. 3 is a schematic view showing the corresponding positions of the light pattern and the light source according to the present invention;

FIG. 4 is a schematic view showing that the light pattern is divided into multiple illumination points according to the present invention;

FIG. 5 is a schematic view showing the connections between the light source and multiple illumination points depending on the counter-projection theory according to the present invention;

FIG. 6 is a three-dimensional drawing showing how the light pattern decides the positions of the lighting elements according to the present invention;

FIG. 7 is a top view showing the light pattern formed by plural light sources according to the present invention;

FIG. 8 is a side view showing the light pattern formed by plural light sources according to the present invention;

FIG. 9 is a three-dimensional drawing showing the lighting elements and the substrate according to the present invention;

FIG. 10 is a schematic view showing the arc substrate of the present invention; and

FIG. 11 is a magnifying view showing a portion of the arc substrate according to the present invention.

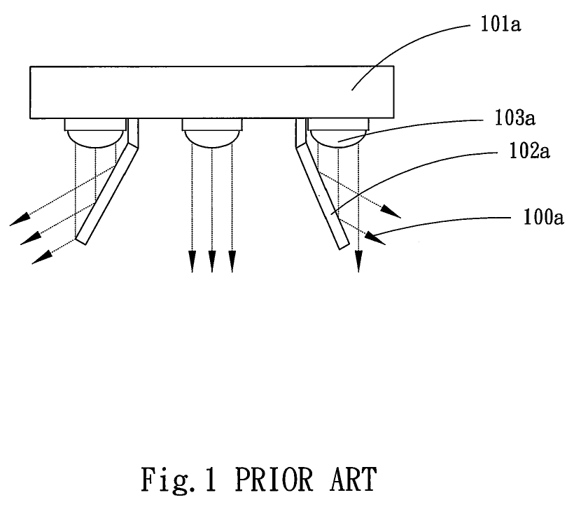

### DESCRIPTION OF THE PREFERRED EMBODIMENT

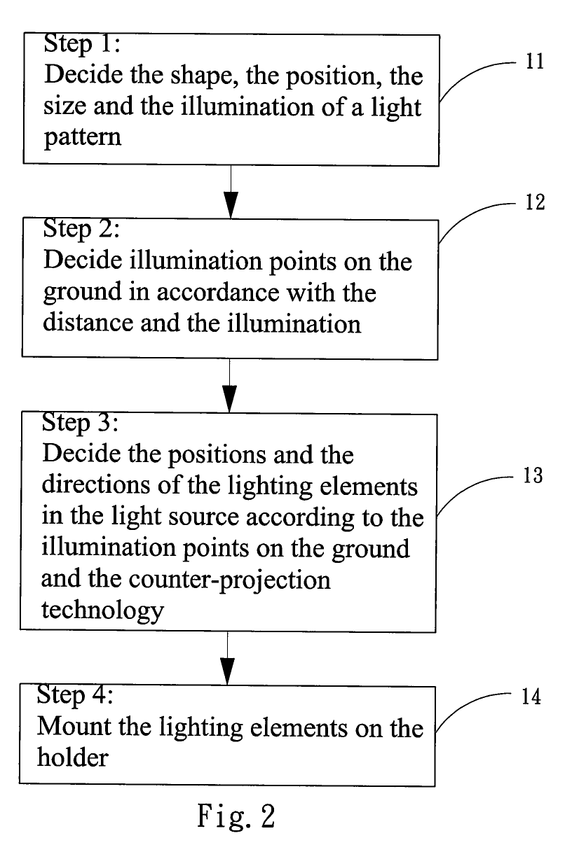

Please refer to FIG. 2 and FIG. 6, in which the positions of the light source 3 and the lighting elements 5 are determined by the counter-projection. The steps are described as below.

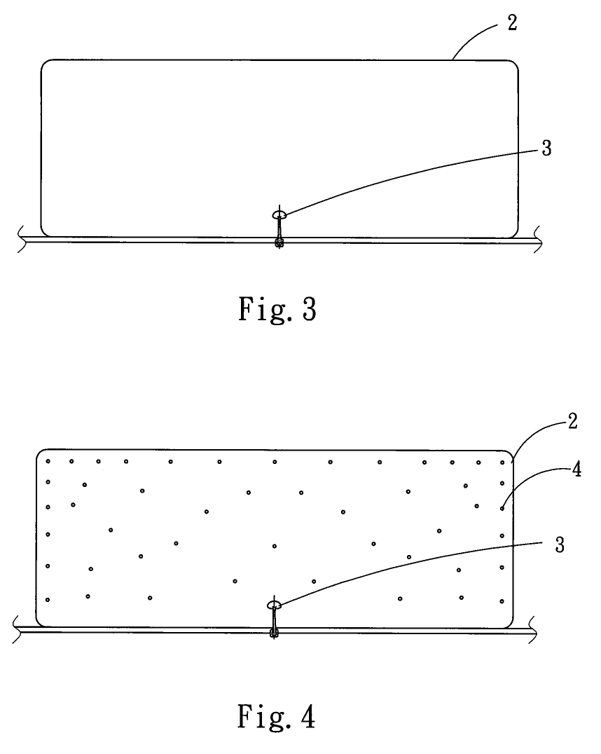

Step 1: Deciding the shape, the position, the size and the illumination of a light pattern (11): according to the user's demand and the position of the light source 3, the shape, the position, the size and the illumination of the light pattern 2 can be configured (as shown in FIG. 3).

Step 2: Deciding illumination points on the ground in accordance with the distance and the illumination (12): multiple illumination points 4 are located in the light pattern 2 according to the distances between the illumination points 4 and the light source 3. The longer the distance from the light source 3, the smaller the illumination area of the illumination point 4, so that the density of the illumination points should be higher concentrated. Here, the illumination area of the illumination point 4 is in reverse proportion to the square of the distance from the light source 3, and the density of the illumination points 4 is in proportion to the square of the distance from the light source 3 (as shown in FIG. 4).

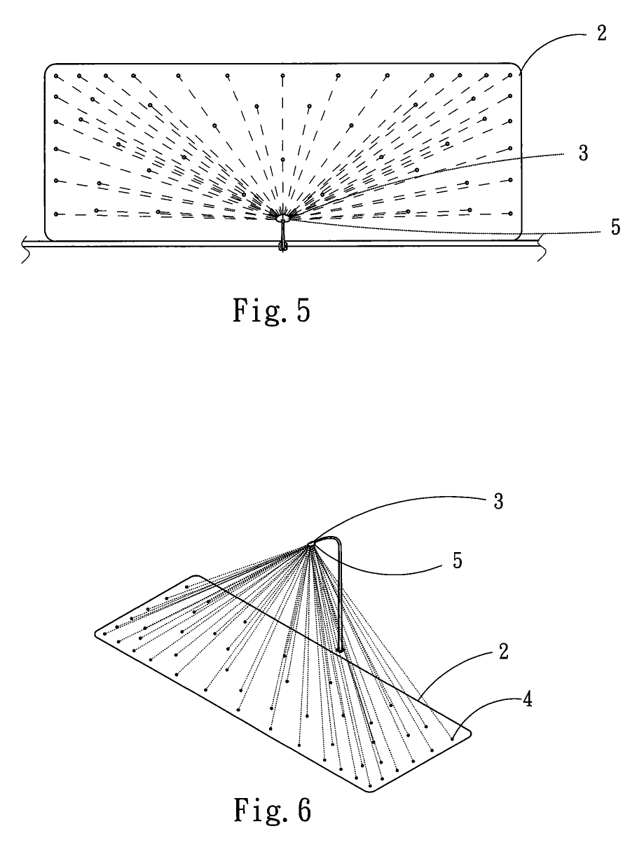

Step 3: Deciding the positions and the directions of the lighting elements in the light source according to the illumination points on the ground and the counter-projection technology (13): after deciding the positions of the illumination points 4, based on the property that light travels in straight line, the shortest straight line from each illumination point 4 to the light source 3 and the connection point of the straight line with the light source 3 are marked (as shown in FIG. 5).

Step 4: Mounting the lighting elements on the light holder (14): mounting the lighting elements 5 on the holder (not shown in the drawings) of the light source 3 in accordance with the marked directions and connection points with the facing directions reverse to the marked directions and the mounting positions identical to the connection points (as shown in FIG. 5 and FIG. 6).

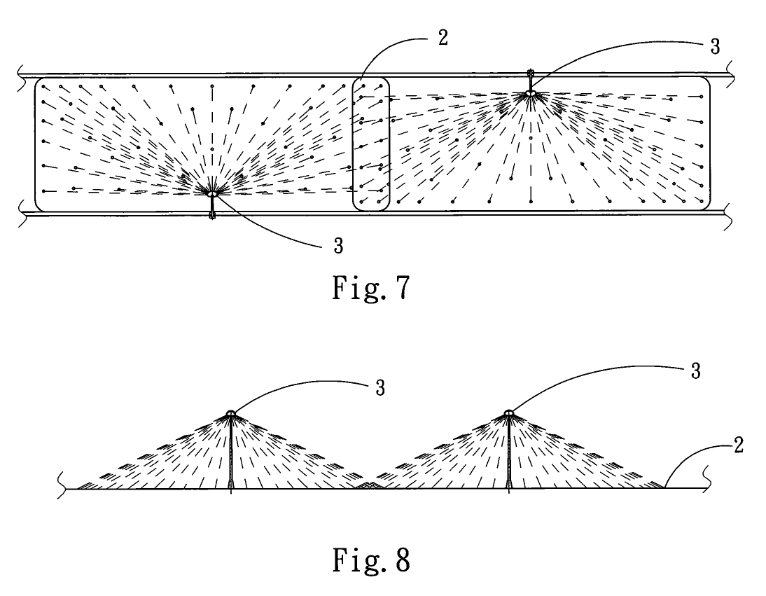

Please refer to FIG. 6, FIG. 7 and FIG. 8. In the method for forming random light pattern and the lamp for the same, based on the property that light travels in straight line, the required light pattern 2 is projected to the light source 3 in a primary optical fashion for deciding the positions, the directions and the number of the lighting elements 5, so as to form the light pattern 2 by one or more light sources 3. Then, according to the required illumination of the light pattern 2, the number of the illumination points 4 can be increased or decreased and the number of the lighting elements 5 mounted in the light source 3 also can be adjusted. Therefore, it can randomly form light pattern 2.

In practical, the present invention is derived from U.S. application Ser. No. 11/907,279 for forming the desired light pattern.

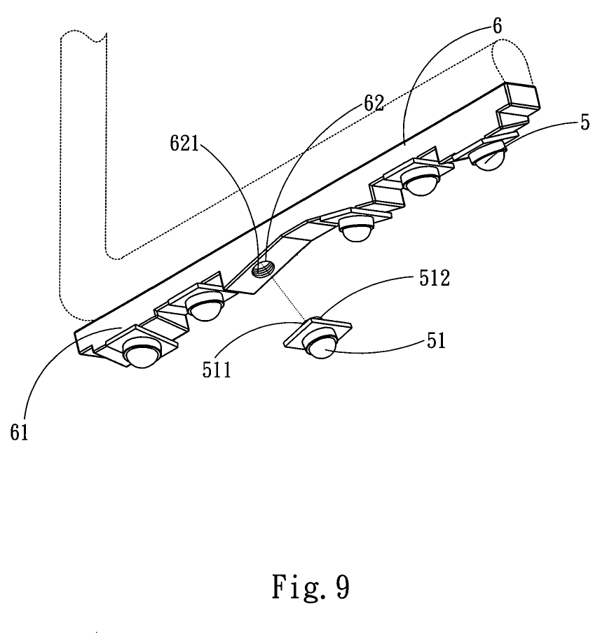

Please refer to FIG. 9. The lamp of the present invention includes plural lighting elements 5 and a holder 6, wherein:

The lighting elements 5 are LEDs 51, each of which, at one side, has a protruded portion 511 with threads 512.

The holder 6 is a substrate made of metal with high heat dissipation efficiency. The holder 6 has a base having plural inclined surfaces 61 toward different directions for conforming to multiple illumination angles, wherein each inclined surface 61 has an indentation 62 with threads 621 corresponding to the threads 512 of the lighting element 5 so as to have a tight engagement therebetween.

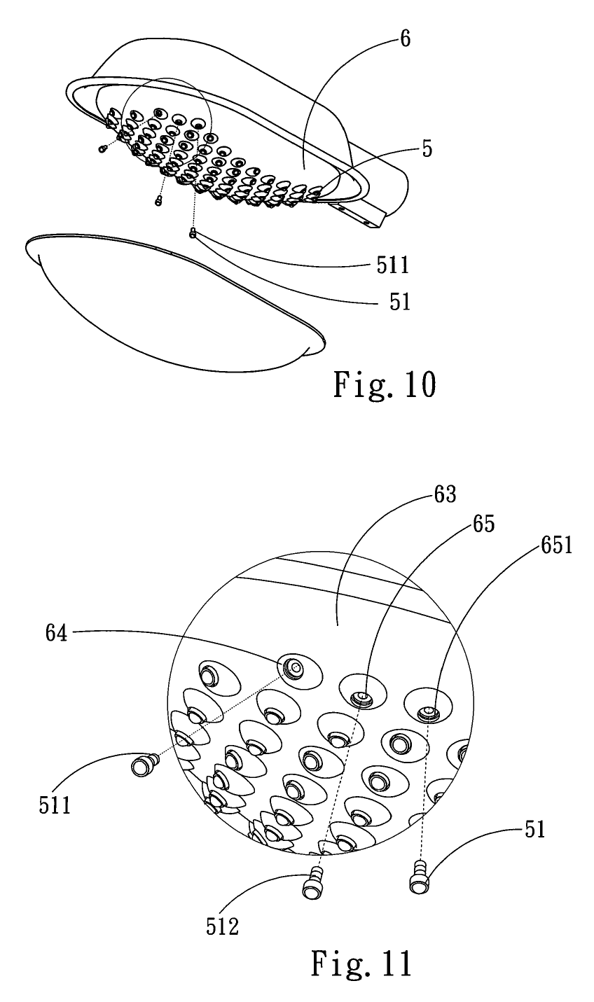

Please refer to FIG. 10 and FIG. 11. The holder 6 also can be an arc substrate 63. The arc substrate 63 has several bases 64, each of which has multiple indentations 65 toward different directions for conforming to multiple illumination angles, and the indentation 65 has threads 651 mounted therein for corresponding to the threads 512 of the lighting elements 5, so as to achieve the engagement therebetween.

Different from the linear or planar arrangement of the conventional lighting elements, the present invention utilizes the technology of counter-projection to find out the positions of lighting elements 5 for producing the desired light pattern.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for forming a random light pattern by using the counter-projection to decide positions of lighting elements in a light source, comprising steps of:
deciding the shape, the position, the size and the illumination of a light pattern;
deciding illumination points on the ground in accordance with the distance and the illumination;
deciding the positions and the directions of lighting elements in the light source according to the illumination points on the ground and the counter-projection technology; and
mounting the lighting elements on a light holder.

2. The method as claimed in claim 1, wherein the step of deciding the illumination points is depending on the distance between the illumination points and the light source, in which the longer the distance from the light source, the higher concentrated the illumination points.

3. The method as claimed in claim 2, wherein the facing directions of the lighting elements are reverse to the directions of the shortest straight lines from the illumination points to the light source.

4. The method as claimed in claim 2, wherein the positions for mounting the lighting elements are the connection points of the shortest straight lines from the illumination points to the light source.

5. A lamp for forming a random light pattern, comprising:
plural lighting elements, which are LEDs having a protruded portion at one side; and
a holder, which is a base with high heat dissipation efficiency, wherein the base has plural indentations for tightly engaging with the protruded portion so as to fix plural lighting elements, characterized in that:
the facing directions of the indentations are adjustable for conforming to required illumination angles.

6. The lamp as claimed in claim 5, wherein the protruded portion of the lighting element has threads thereon, and the indentation of the holder has threads corresponding to the threads of the protruded portion.

7. The lamp as claimed in claim 5, wherein the holder is a metal substrate.

8. The lamp as claimed in claim 7, wherein the holder is an arc substrate having plural indentations mounted thereon and the facing directions of the indentations are adjustable for conforming to required projection angles.

9. The lamp as claimed in claim 8, wherein the indentation has threads corresponding to the threads of the protruded portion.
